(19) United States
(12) Patent Application Publication
(10) Pub. No.: US 2011/0298576 A1
(43) Pub. Date: Dec. 8, 2011

(54) TRIPPING UNIT FOR CIRCUIT BREAKER

(75) Inventors: Guenter Baujan, Troisdorf (DE); Klaus Dauer, Koblenz (DE)

(73) Assignee: EATON INDUSTRIES GMBH, Bonn (DE)

(21) Appl. No.: 13/153,548

(22) Filed: Jun. 6, 2011

(30) Foreign Application Priority Data
Jun. 8, 2010 (EP) 10165233.7

(51) Int. Cl. H01H 85/02

(52) U.S. Cl. 337/5

(57) ABSTRACT

A tripping unit is configured to send an electrical tripping-signal to a switching unit of a circuit breaker so as to trip main contacts of main circuits of the circuit breaker in response to a detection of a current being above a predetermined level in at least one of the main circuits. The tripping unit includes a fuse configured to be connected in series to a main circuit of the circuit breaker and a detection unit connected in parallel with the fuse and configured to generate the tripping signal for the switching unit in response to the fuse being blown.

### CROSS REFERENCE TO RELATED APPLICATIONS

This application claims priority to European Patent Application No. EP 10 165 233.7, filed Jun. 8, 2010, which is hereby incorporated by reference herein in its entirety.

### FIELD

The invention relates to a tripping unit for tripping the main contacts of main circuits of a circuit breaker by sending an electrical tripping-signal to a switching unit of the circuit breaker when a current above a certain level is detected in at least one of the main circuits.

### BACKGROUND

Circuit breakers can be configured as motorcircuit breakers or as automatic circuit breakers that are employed to switch a load on and off and that have a protective function by separating or interrupting the load in case of an electrical fault. Electrical faults can be e.g. short circuits or overcurrents. Such circuit breakers comprise essentially a base module, a manual actuating device, an electronic control unit, an actor unit and a tripping element. Through the use of the manual actuating device, at least a switching mechanism is activated by means of a rotary knob and of an actuating shaft, whereby the actuating device is accommodated in a housing part that protrudes from the operating front of the circuit breaker.

As a motor circuit breaker, circuit breakers can have a tripping behavior that is adapted to the electric motor to be protected, or which serve as line circuit breakers to protect electric lines or systems against thermal overload or short-circuit damage. The tripping behavior and thus the use of such circuit breakers are determined by the thermal and short-circuit tripping values. To implement different tripping behavior in a circuit breaker, it is well known in the state of the art to build up a modular circuit breaker which includes a replaceable tripping module.

The German patent application DE 36 42 719 A1 describes a manually operated protective circuit breaker which comprises a plug-in exchangeable overcurrent tripping unit.

These tripping units can comprise very complex mechanical and/or electrical parts and the production of these kind of tripping units can be very expensive.

Another drawback of such similar circuit breakers is that the thermal elongation, which activates the tripping unit, must be very high.

### SUMMARY

In an embodiment, the present invention provides a tripping unit configured to send an electrical tripping-signal to a switching unit of a circuit breaker so as to trip main contacts of main circuits of the circuit breaker in response to a detection of a current being above a predetermined level in at least one of the main circuits. The tripping unit includes a fuse configured to be connected in series to a main circuit of the circuit breaker and a detection unit connected in parallel with the fuse and configured to generate the tripping signal for the switching unit in response to the fuse being blown.

### BRIEF DESCRIPTION OF THE DRAWINGS

Exemplary embodiments of the invention are described in more detail below, with reference to the drawings, in which:

FIG. 1a is a schematic depiction of a front view of a tripping unit;

FIG. 1b is a schematic depiction of a side view of a tripping unit;

FIG. 2 is a schematic depiction of the internal assembly of a tripping unit;

FIG. 3 is a schematic depiction of the circuit breaker and a tripping unit drawn in form of a block diagram.

### DETAILED DESCRIPTION

An aspect of the present invention is to provide at tripping unit that overcomes the above drawbacks. In an embodiment of the present invention a tripping unit for tripping the main contacts of main circuits of a circuit breaker by sending an electrical tripping-signal to a switching unit of the circuit breaker when a current above a certain level is detected in at least one of the main circuits is characterized in that the tripping unit comprises at least one fuse which is connected in series to a main circuit of the circuit breaker and wherein a detection unit which is connected in parallel to the at least one fuse is adapted to generate the tripping-signal for the switching unit after at least one of the fuses is blown. A fuse, especially a micro-fuse, reacts very fast in case of an over-current. A fast reaction time of the fuse results in a high protection of connected devices such as drives and motors. It is also cost effective to just replace a blown fuse instead of replacing the whole tripping unit.

In an embodiment of the invention, each main circuit of the circuit breaker is connected in series with a fuse of the tripping unit. In this embodiment, all main circuits can be controlled by the tripping unit of the circuit breaker.

In a further embodiment of the invention, the detection unit comprises a rectifier package which rectifies the electrical tripping-signal for the switching unit after the fuse is blown. A rectified tripping-signal can be easier to handle in the electronic part of the switching unit.

In a further embodiment of the invention, a resistor is connected in series with the rectifier package to reduce the voltage of the rectified electrical tripping-signal for the switching unit after the fuse is blown. A low current value means that smaller electrical components can be used which is cost effective.

In a further embodiment of the invention, the tripping unit is plugged into the circuit breaker. It is easy to replace the tripping unit with other tripping units comprising different parameters.

In a further embodiment of the invention, the at least one fuse is removable arranged in the tripping unit. Advantageously the at least one fuse is screwable arranged in the tripping unit. It is easy to replace a blown fuse and reactivate the tripping unit.

In a further embodiment of the invention, the at least one fuse is a micro-fuse.

The invention further relates to a circuit breaker with a tripping unit which comprises the features described above.

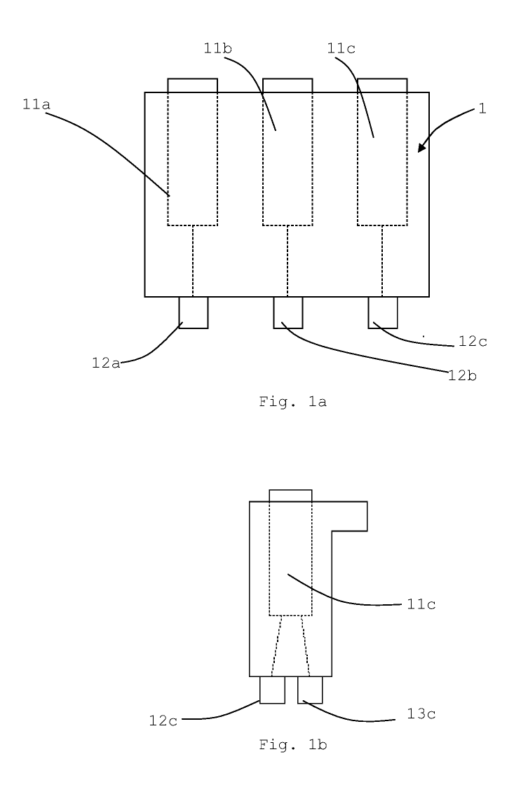

FIG. 1a and 1b depict a tripping unit 1 comprising a body which contains three fuses 11a, 11b, 11c. The fuses 11a, 11b, 11c are reachable from outside the body of the tripping unit 1. It is easy to replace a fuse 11a, 11b, 11c, when it is blown. The fuses 11a, 11b, 11c are preferably screwed in a fuse fitting. The fuses 11a, 11b, 11c can also be plugged against a spring force into a fuse fitting. Also other kinds of fittings are conceivable.

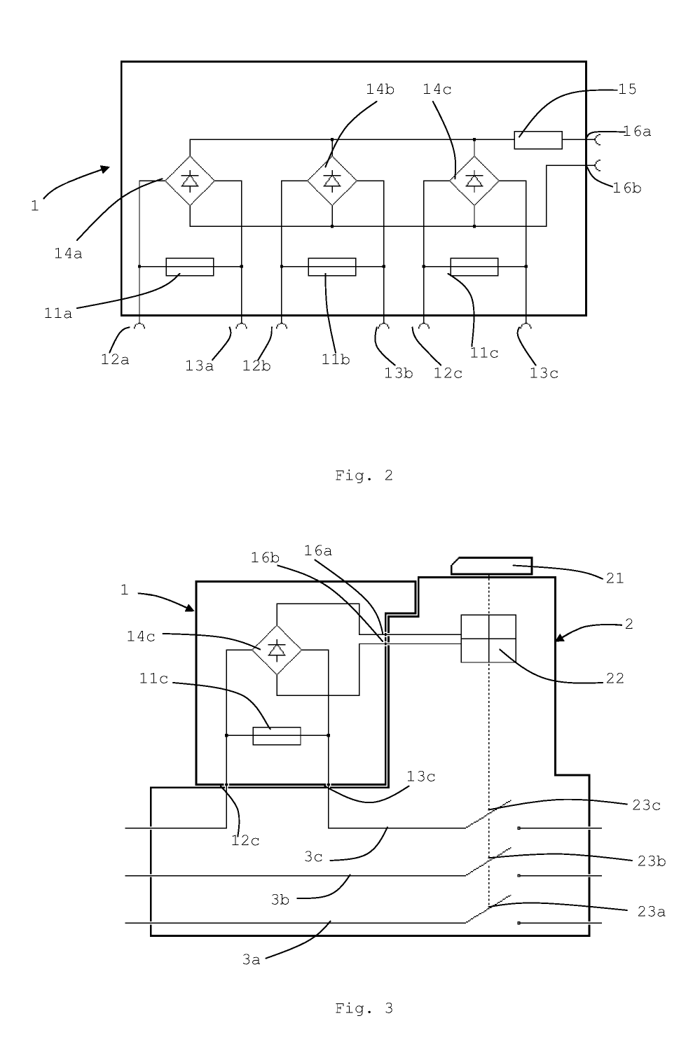

FIG. 2 depicts the internal assembly of an embodiment of a tripping unit 1. This embodiment comprises a tripping unit 1 including three fuses 11a, 11b, 11c. It is also possible to build up a tripping unit including more or less fuses 11a, 11b, 11c. The number of fuses 11a, 11b, 11c depends on the number of main circuits 3a, 3b, 3c which should be controlled. FIG. 3 is a schematic depiction of a circuit breaker 2 and a tripping unit 1. For a clear view, only one fuse 11c is shown which is connected in series with one main circuit 3c. FIG. 2 and FIG. 3 will be described in combination further on.

The tripping unit 1 is plugged onto the circuit breaker 2 such that the connectors 12a, 13a, 12b, 13b, 12c, 13c connect the fuses 11a, 11b, 11c in series to the main circuits 3a, 3b, 3c. The connectors 16a, 16b connect the switching unit 22 of the circuit breaker 2 to the tripping-signal line of the tripping unit 1. The switching unit 22 is adapted to switch off the main contacts 23a, 23b, 23c when a tripping-signal from the tripping unit 1 is detected. It is also possible to switch the main contacts 23a, 23b, 23c by manually turning the main switch 21 of the circuit breaker 2. When the switching unit 22 detects a tripping-signal and switches off the main contacts 23a, 23b, 23c, the main switch 21 of the circuit breaker 2 will also turn in an OFF-position.

When a current above a specified value flows through one of the main circuits 3a, 3b, 3c and also through one of the fuses 11a, 11b, 11c which is connected in series with the main circuits 3a, 3b, 3c, this fuse 11a, 11b, 11c blows. The specified value of the current is the minimum current at which each of the fuses 11a, 11b, 11c blows. By inserting different kind of fuses 11a, 11b, 11c into the tripping unit 1, different values could be selected at which the circuit breaker 2 switches off the main contacts 23a, 23b, 23c. When one of the fuses 11a, 11b, 11c is blown, a voltage applies to one of the detection unit 14a, 14b, 14c which is connected in parallel to the blown fuse 11a, 11b, 11c. The tripping signals of all detection units 14a, 14b, 14c are connected such that a single tripping-signal line and a single ground line are connected via the connector 16a, 16b with the switching unit 22.

The detection unit 14a, 14b, 14c can be every kind of resistor or preferably a rectifier package which is adapted to rectify the alternating voltage on the main circuits 3a, 3b, 3c. The tripping-signal which is generated by the rectifier package 14a, 14b, 14c can be detected by the switching unit 22 of the circuit breaker 2. The current-value of the tripping-signal can be reduced by a resistor 15 which is connected in series to the tripping-signal line. After a tripping-signal is present at one of the rectifier packages 14a, 14b, 14c, the switching unit disconnects the main contacts 23a, 23b, 23c of the main circuits 3a, 3b, 3c. Preferably an indicator light at the tripping unit 1 can indicate a blown fuse 11a, 11b, 11c. Therefore the indicating light can be connected in series to the generated tripping-signal. Preferably every fuse 11a, 11b, 11c comprises an indicator light such that an operator can detect which fuse 11a, 11b, 11c is blown. Therefore indicator lights must be inserted in parallel to each fuse 11a, 11b, 11c.

After the problem in the main circuit 3a, 3b, 3c, which causes the over-current, is solved, the blown fuse 11a, 11b, 11c can be replaced by an operator. After the fuse 11a, 11b, 11c is replaced the main circuits can be switched on by turning the main switch 21 of the circuit breaker 2.

While the invention has been particularly shown and described with reference to preferred embodiments thereof, it will be understood by those skilled in the art that various changes in form and details may be made therein without departing from the spirit and scope of the invention.

What is claimed is:

1: A tripping unit configured to send an electrical tripping signal to a switching unit of a circuit breaker so as to trip main contacts of main circuits of the circuit breaker in response to a detection of a current being above a predetermined level in at least one of the main circuits, the tripping unit comprising:
a fuse configured to be connected in series with a main circuit of the circuit breaker; and
a detection unit connected in parallel with the fuse and configured to generate the tripping signal for the switching unit in response to the fuse being blown.

2: The tripping unit recited in claim 1, further comprising at least one additional fuse, each additional fuse being configured to be connected in series with a respective additional main circuit of the circuit breaker,
wherein the detection unit is in parallel with the additional fuses and configured to generate the tripping signal for the switching unit in response to at least one of the at least one additional fuses being blown.

3: The tripping unit recited in claim 1, wherein the detection unit includes a rectifier package configured to rectify the electrical tripping-signal for the switching unit.

4: The tripping unit recited in claim 3, further comprising a resistor connected in series with the rectifier package and configured to reduce a voltage of the rectified electrical tripping signal for the switching unit.

5: The tripping unit recited in claim 1, wherein the tripping unit is pluggable into the circuit breaker.

6: The tripping unit recited in claim 1, wherein the fuse is removably disposed in the tripping unit.

7: The tripping unit recited in claim 6, wherein the fuse is screwed into the tripping unit.

8: The tripping unit recited in claim 1, wherein the fuse is a micro-fuse.

9: A circuit breaker comprising:
a circuit breaker unit including a plurality of main circuits having respective main contacts, and a switching unit configured to trip the main contacts of the main circuits; and
a tripping unit configured to send an electrical tripping signal to the switching unit of the circuit breaker so as to trip the main contacts in response to a detection of a current being above a predetermined level in at least one of the main circuits, the tripping unit including:
a fuse configured to be connected in series with a main circuit of the circuit breaker; and
a detection unit connected in parallel with the fuse and configured to generate the tripping signal for the switching unit in response to the fuse being blown.

10: The circuit breaker recited in claim 9, further comprising at least one additional fuse, each additional fuse being configured to be connected in series with a respective additional main circuit of the circuit breaker,
wherein the detection unit is in parallel with the additional fuses and configured to generate the tripping signal for the switching unit in response to at least one of the at least one additional fuses being blown.

11: The circuit breaker recited in claim 9, wherein the detection unit includes a rectifier package configured to rectify the electrical tripping signal for the switching unit.

12: The circuit breaker recited in claim 11, wherein the tripping unit includes a resistor connected in series with the rectifier package and configured to reduce a voltage of the rectified electrical tripping signal for the switching unit.

13: The circuit breaker recited in claim 9, wherein the tripping unit plugs into the circuit breaker unit.

14: The circuit breaker recited in claim 9, wherein the fuse is removably disposed in the tripping unit.

15: The circuit breaker recited in claim 14, wherein the fuse is screwed into the tripping unit.

16: The circuit breaker recited in claim 9, wherein the fuse is a micro-fuse.
